(19) United States
(12) Patent Application Publication
(10) Pub. No.: US 2007/0102587 A1
(43) Pub. Date: May 10, 2007

(54) Wing leading edge slat system

(75) Inventors: Kelly T. Jones, Snohomish, WA (US); Stephen J. Fox, Everett, WA (US); Stephen R. Amorosi, Seattle, WA (US)

Correspondence Address: WEISS & MOY PC, 4204 NORTH BROWN AVENUE, SCOTTSDALE, AZ, 85251, US

(73) Assignee: THE BOEING COMPANY

(21) Appl. No.: 11/268,384

(22) Filed: Nov. 7, 2005

(51) Int. Cl. B64C 3/50

(52) U.S. Cl. 244/214

(57) ABSTRACT

A mechanism for extending and supporting a high-lift device relative to an airfoil has a pair of support ribs coupled to the airfoil. A carrier track is pivotally coupled to the high-lift device and positioned between the pair of support ribs. The carrier track has a slot opening along a lower length thereof. A gear rack is coupled within the slot opening. A pinion gear is positioned between the support ribs and below the carrier track. The pinion gear engages with the gear rack for extending the high-lift device relative to the airfoil. A plurality of rollers is rotateably coupled to the support ribs and in bearing contact with the carrier track. At least one roller is positioned above the carrier track and a second roller is positioned below the carrier track. The second roller is positioned concentrically with the pinion gear.

### BACKGROUND OF THE INVENTION

1. Field of the Invention

The present invention relates generally to an airplane wing, and more particularly, to an airplane wing leading edge slat system wherein the pinion gear assembly is located concentrically with the lower aft roller to reduce the number of components in the wing and increase space in the wing for other systems.

2. Background Information

Slats are small aerodynamic surfaces on the leading edge of an airplane wing. Leading edge slats are used for altering the aerodynamic shape of a wing airfoil section. In a normal cruise configuration, the leading edge slats are placed in a retracted position to provide the fixed wing an optimized aerodynamic configuration. During take-off and climbing, the leading edge slats are moved forward to an intermediate location to extend the effective cord length of the wing. This will improved lift performance of the wing while keeping drag within reasonable limits. In a high lift configuration, the leading edge slats are generally moved further forward from the takeoff and climb position so that the slat has a greater downward slant to increase the camber of the slat/wing combination. In this configuration, the leading edge slats form with the fixed wing an aerodynamic slot which results in airflow from beneath the slats upwardly through the slot and over the upper forward surface portion of the fixed wing. This configuration is commonly used when the aircraft is landing.

Due to the limited stowage volume in the wing cross-section, designing actuation systems for moving and positioning the leading edge slats in the wing has been difficult. These systems tend to take up a large amount of area in the wing cross-section. Newer airplanes are developing more aerodynamically aggressive wing plans in order to achieve greater performance. Thus, newer wing designs are getting smaller while loading of the flight control surfaces remain the same. The combination of a shorter chord for the fixed leading edge structure as well as a reduced front spar height, and relatively high flight control surface loads make the integration of actuation systems for moving and positioning the leading edge slats in the wing extremely difficult.

Therefore, it would be desirable to provide an actuation system for moving and positioning the leading edge slats in the wing that overcomes the above problems. The actuation system would have a reduced number of components thereby increasing the space in the wing for other systems.

### SUMMARY OF THE INVENTION

A mechanism for extending and supporting a high-lift device relative to an airfoil has a pair of support ribs coupled to the airfoil. A carrier track is pivotally coupled to the high-lift device and positioned between the pair of support ribs. The carrier track has a slot opening along a lower length thereof. A gear rack is coupled within the slot opening. A pinion gear is positioned between the support ribs and below the carrier track. The pinion gear engages with the gear rack for extending the high-lift device relative to the airfoil. A plurality of rollers is rotateably coupled to the support ribs and in bearing contact with the carrier track. At least one roller is positioned above the carrier track and a second roller is positioned below the carrier track. The second roller is positioned concentrically with the pinion gear.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and the accompanying drawings, wherein:

FIG. 1 is a plan view of an airplane wing having a series of slat panels at an extended position normal to the leading edge thereof;

FIG. 2 is a cross-sectional view taken in the direction indicated by the line 2-2 of FIG. 1 which is normal to the leading edge of the wing and shows a slat panel in the extended position;

FIG. 3 is a view similar to FIG. 2 wherein the slat panel is in a retracted or stowed position completing the leading edge profile of the wing airfoil section envelope;

FIG. 4 is a cross-sectional view taken along line 4-4 of FIG. 2 in the direction indicated; and

FIG. 5 is a cross-sectional view taken along line 5-5 of FIG. 3 in the direction indicated.

### DETAILED DESCRIPTION OF THE PREFERRED EMBODIMENTS

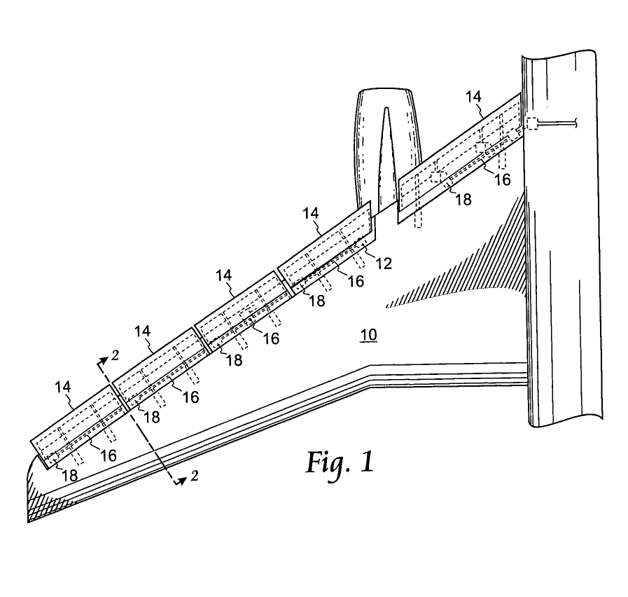

Referring to FIG. 1, a plan view of an outboard, leading edge section of an airplane wing 10 is shown. The wing 10 has a front wing spar 12 and a spanwise series of slat panels 14 along the leading edge of the wing 10. A power drive system is mounted spanwise along the front wing spar 12 for extending or retracting the slat panels 14 relative to a fixed wing leading edge. In accordance with one embodiment, the power drive system, which will be described in more detail below, comprises: a power drive unit (not shown) such as a hydraulic or electric drive motor for rotating a spanwise series of axially aligned shafts or torque tubes 16 (hereinafter shafts 16), at a relatively high speed. The shafts 16 operate the extension or retraction mechanism of the slat panels 14 through a speed reducer and torque converter unit hereinafter referred to a rotary actuator 18. Each of the rotary actuators 18 is mounted to a slat support track having a gear rack segment and pinion drive gear (not shown) coupled to the output drive shaft 16 of the rotary actuator 18. The output drive shafts 16 operate through the rotary actuators 18 and function to controllably tie and synchronize one slat panel to its adjacent slat panel, without any additional slat drive synchronization mechanism being required.

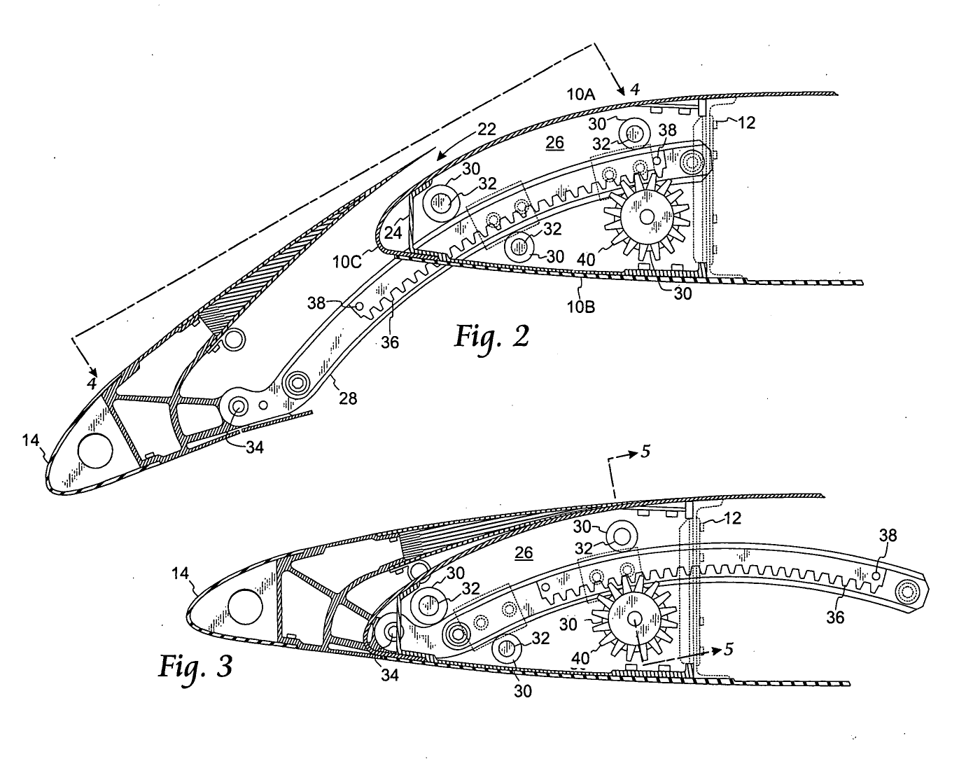

Referring now to FIG. 2, a chordwise cross-sectional view taken in the direction indicated by the line 2-2 of FIG. 1 shows a wing leading edge slat 14 at a fully extended position. This slat position is generally used for the landing mode of airplane operation. An aerodynamic slot 22 is formed between the leading edge of the fixed wing structure and the trailing edge of the extended slat panel 14.

The fixed leading edge section of the wing has an upper surface skin panel 10A and a lower surface skin panel 10B. The upper and lower skin panels 10A and 10B are attached to a rigid leading edge nose structure 10C having a spanwise nose beam 24. The entire structure is supported by chordwise wing ribs 26 which are fixedly attached to a spanwise structural member such as the front wing spar 12.

Each individual slat panel 14 is supported in the extended operating position by a curved slat support track 28 (hereinafter curved track 28). The curved tracks 28 are the main carrier tracks for the slat panels 14. The curved track 28 is mounted on rollers 30 and positioned between a pair of the wing ribs 26. The rotational axis 32 of each roller 30 is fixed to the pair of wing ribs 26. Bearings 44 are placed on each side of the rollers 30 on the rotation axis 32 to support and reduce the friction of motion.

The forward end of the curved track 28 is pivotally coupled at 34 to the slat panel 14. In general, there are two spanwise spaced main curved tracks 28 used to support each individual slat panel 14. The curved tracks 28 can be located at the ends of the slat panel 14 or spaced spanwise apart at an optimum structural distance of approximately one-fourth of the length of a slat panel 14.

Each curved track 28 has an internally mounted gear rack segment 36. The gear rack segment 36 is positioned within an inverted U-shaped channel or slot of the curved track 28. The gear rack segment 36 is located on the cross-sectional, vertical centerline of the curved track 28 in order to produce a symmetrical drive force for extension and retraction of the slat panel 14. An asymmetrical drive force, such as that produced by a gear rack mounted to only one side of a track member, would produce unacceptable side loads, friction and driving forces. Further, if a pair of gear racks were straddle mounted, one on each side of a track member, such that a drive force was produced on both sides of the central track member, then synchronized or balanced gear tooth loading would present a problem in addition to an increase in weight and cost.

Fasteners 38, such as bolts and nuts, are used to secure the gear rack segment 36 within a channel of the curved track 28. In general, the fasteners 38 should be located at or near the low stressed neutral bending axis of the curved track 28 as shown in FIG. 2. If the fasteners 38 are located at different locations, such as passing through the highly stressed flanges of the curved track 28, the bending strength characteristics of the curved track may be seriously compromised.

The gear rack segment 36 engages a pinion drive gear 40. The rotation of the pinion drive gear 40 meshes with gear rack segment 36, thereby extending or retracting the slat panel 14. The rollers 30 support the curved track 28 as the slat panel 14 is extended or retracted. The rollers 30 are supported by bolts which form the rotational axis 32 for each roller 30. The bolts pass through the pair of the wing ribs 26, one on each side thereof, to provide for maximum load carrying ability. This straddle-mounted dual support contrasts with a cantilevered roller configuration which provides much less load carrying capability.

Referring to FIG. 3, the slat panel 14 is in the fully retracted position. The leading edge slat panels 14 are placed in a retracted position to provide the fixed wing an optimized aerodynamic configuration. Due to limited cross-sectional thickness of the airfoil at the location of the spanwise outboard slat panel 14, there is a limited stowage volume for the slat actuating mechanism. However, the present invention, relates to the pinion gear assembly being located concentrically with the lower aft roller to reduce the number of components in the wing and increase space in the wing for other systems.

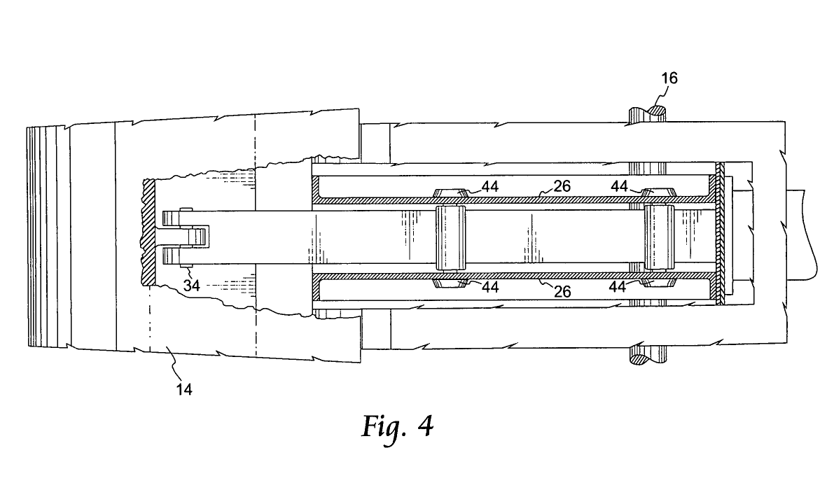

Referring now to FIGS. 2-5, the shafts 16 operate the extension or retraction mechanism of the slat panels 14 through the rotary actuator 18. Each of the rotary actuators 18 is generally mounted to one of the pair of the wing ribs 26. The drive gear 40 is coupled to the shaft 16. An output sleeve may be placed on the shaft 16 to couple the drive gear 40 to the shaft 16. The drive gear 40 meshes with gear rack segment 36 to extend or retract the slat panel 14.

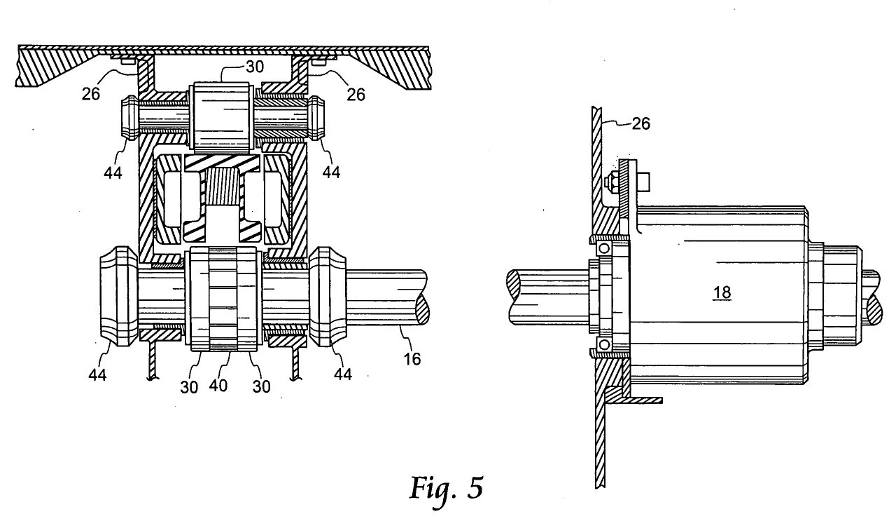

As seen more clearly in FIG. 5, in order to reduce the number of components in the wing and increase space in the wing for other systems the drive gear 40 is positioned concentrically between one or more rollers 30 and bearings 44. The rollers 30 that are positioned concentrically with the drive gear 40 are generally the rollers 30 in the lower aft position. The rollers 30 positioned concentrically with the drive gear 40 may be mounted on bearings, pressed, or otherwise fixed on the shaft 16. If the rollers 30 positioned concentrically with the drive gear 40 are pressed on the shaft 16, the outside diameter of the rollers 30 on the shaft 16 should match as closely as possible the pitch diameter of the drive gear 40 in order to minimize scrubbing due to relative slip between the roller 30 and the curved track 28. By positioning the drive gear 40 concentrically between the rollers 30, the number of components in the wing 10 is reduced thereby freeing up significantly more space in the wing for other systems.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A mechanism for extending and supporting a high-lift device relative to an airfoil, comprising:
a pair of support ribs coupled to the airfoil;
a carrier track pivotally coupled to the high-lift device and positioned between the pair of support ribs and having a slot opening along a lower length thereof;
a gear rack coupled within the slot opening;
a pinion gear positioned between the support ribs and below the carrier track, which engages with the gear rack for extending the high-lift device relative to the airfoil; and
a plurality of rollers rotateably coupled to the support ribs and in bearing contact with the carrier track, wherein at least one roller is positioned above the carrier track and a second roller is positioned below the carrier track, the second roller positioned concentrically with the pinion gear.

2. A mechanism for extending and supporting a high-lift device relative to an airfoil in accordance with claim 1 wherein an outside diameter of the second roller and the pitch diameter of the pinion gear are sized to minimize scrubbing due to relative slip between the second roller and the carrier track.

3. A mechanism for extending and supporting a high-lift device relative to an airfoil in accordance with claim 1 wherein an outside diameter of the second roller is approximately equal to a pitch diameter of the pinion gear.

4. A mechanism for extending and supporting a high-lift device relative to an airfoil in accordance with claim 1, further comprising:
a rotational shaft member, wherein the pinion gear and the second roller are rotateably coupled on the rotation shaft member; and
a rotary actuator coupled to the support ribs and the rotational shaft.

5. A mechanism for extending and supporting a high-lift device relative to an airfoil in accordance with claim 1, further comprising a pair of bearings positioned on each side of each of the plurality of rollers.

6. A mechanism for extending and supporting a high-lift device relative to an airfoil in accordance with claim 5, further comprising a pair of bearings rotateably coupled on the rotation shaft member, the pinion gear and the second roller positioned between the pair of bearings.

7. A mechanism for extending and supporting a high-lift device relative to an airfoil, comprising:
a pair of support ribs coupled to the airfoil;
a carrier track pivotally coupled to the high-lift device and positioned between the pair of support ribs and having a slot opening along a lower length thereof;
a gear rack coupled within the slot opening;
a pinion gear positioned between the support ribs and below the carrier track, which engages with the gear rack for extending the high-lift device relative to the airfoil; and
a plurality of rollers rotateably coupled to the support ribs and in bearing contact with the carrier track, wherein at least one pair of rollers is positioned above the carrier track and a second pair of rollers is positioned below the carrier track, wherein one roller of the second pair of rollers is positioned concentrically with the pinion gear.

8. A mechanism for extending and supporting a high-lift device relative to an airfoil in accordance with claim 7 wherein an outside diameter of the second roller and the pitch diameter of the pinion gear are sized to minimize scrubbing due to relative slip between the second roller and the carrier track.

9. A mechanism for extending and supporting a high-lift device relative to an airfoil in accordance with claim 7 wherein an outside diameter of the second roller is approximately equal to a pitch diameter of the pinion gear.

10. A mechanism for extending and supporting a high-lift device relative to an airfoil in accordance with claim 7, further comprising:
a rotational shaft member, wherein the pinion gear and the second roller are rotateably coupled on the rotation shaft member; and
a rotary actuator coupled to the support ribs and the rotational shaft.

11. A mechanism for extending and supporting a high-lift device relative to an airfoil in accordance with claim 10, further comprising a pair of bearings rotateably coupled on the rotation shaft member, the pinion gear and the second roller positioned between the pair of bearings.

12. A mechanism for extending and supporting a high-lift device relative to an airfoil, comprising:
a pair of support ribs coupled to the airfoil;
a carrier track pivotally coupled to the high-lift device and positioned between the pair of support ribs and having a slot opening along a lower length thereof;
a gear rack coupled within the slot opening;
a pinion gear positioned between the support ribs and below the carrier track, which engages with the gear rack for extending the high-lift device relative to the airfoil; and
a plurality of roller assemblies rotateably coupled to the support ribs and in bearing contact with the carrier track, wherein at least one roller assembly is positioned below the carrier track and concentrically with the pinion gear.

13. A mechanism for extending and supporting a high-lift device relative to an airfoil in accordance with claim 12, wherein each of the plurality of roller assemblies comprises:
a rotational axle coupled to the support ribs;
a roller coupled to the rotational axle; and
a pair of bearings coupled on the rotational axle.

14. A mechanism for extending and supporting a high-lift device relative to an airfoil in accordance with claim 13
a rotational shaft member, wherein the pinion gear and the roller of the least one roller assembly positioned below the carrier track are rotateably coupled on the rotation shaft member, the rotational shaft member being the rotational axle of the roller of the least one roller assembly positioned below the carrier track; and
a rotary actuator coupled to the support ribs and the rotational shaft.

15. A mechanism for extending and supporting a high-lift device relative to an airfoil in accordance with claim 14 wherein an outside diameter of the roller of the least one roller assembly positioned below the carrier track and the pitch diameter of the pinion gear are sized to minimize scrubbing due to relative slip between the roller of the least one roller assembly positioned below the carrier track and the carrier track.

16. A mechanism for extending and supporting a high-lift device relative to an airfoil in accordance with claim 1 wherein an outside diameter of the roller of the least one roller assembly positioned below the carrier track is approximately equal to a pitch diameter of the pinion gear.
